(19) United States
(12) Patent Application Publication
(10) Pub. No.: US 2024/0319994 A1
(43) Pub. Date: Sep. 26, 2024

(54) Code Centric Software Project Management System

(71) Applicant: Rafael Leonhard Spring, Wiesbaden (DE)

(72) Inventor: Rafael Leonhard Spring, Wiesbaden (DE)

(21) Appl. No.: 18/126,312

(22) Filed: Mar. 24, 2023

(51) Int. Cl. G06F 8/73; H04L 51/07

(52) U.S. Cl. CPC G06F 8/73; H04L 51/07

(57) ABSTRACT

A source-code centric project management system is disclosed. The system is comprised of various subsystems, modules and interconnections that allow software developers, through the use of connected systems, to use code comments and commit messages to perform a variety of project-management-related tasks, such as opening, modifying and closing tickets in an Issue Tracking System, team communication, progress documentation and task assignment. The system further contains a module for rendering interactive commit graphs of a managed source code repository in a visually clean manner.

### REFERENCE TO RELATED APPLICATIONS

This application claims benefits of the priority date of U.S. Provisional Application No. 63/323,224, filed on Mar. 24, 2022

### BACKGROUND OF THE INVENTION

Software development is a complex process which can involve the use of various different tools and systems. For example, a given software development project may involve, among other systems, a source code management system (“SCM”), an issue-tracking system (ITS), a code-review system, a project documentation or wiki system, a bug tracking system and a feature planning system.

However in a typical project developers mostly interact with software that is core to their workflow, in particular the SCM and systems for testing, building and deployment. On the other hand project managers and higher-level management need the ability to track the state and progress of a project for planning purposes but cannot concern themselves with the complexity of SCM or other developers' tools.

It is therefore often required from developers to carry out project management and progress tracking functions within project management tools that are not core to their workflow, which may lead to friction and unsatisfactory results.

The disclosed invention therefore presents a solution to these challenges by equipping developers with tools to more effectively carry out project management tasks while being native to their workflow.

### BRIEF SUMMARY OF THE INVENTION

A system and methods for source-code centric project management is disclosed. The system is comprised of subsystems and modules including a Commenting Module, a Commit Graph Rendering Module, an SCM Extension Module, their interconnections as well as their connections to other related systems and modules.

Embodiments of the systems, modules, devices and methods described in the present disclosure enable developers to utilize familiar methods (in particular code comments and SCM commit messages that are specifically formatted and augmented) and interfaces (in particular commit graphs) to carry out a variety of project-management related functions, including, but not limited to, opening, modifying and closing tickets in an issue tracking system (ITS), team communication, progress documentation and task assignment, through connected project management systems.

In an exemplary use case a developer creates a source code comment containing special tokens and keywords that cause the delivery of events, notifications and/or messages to connected systems and receivers, as well as the update of an interactive visualization of the commit graph of the underlying source code repository.

The disclosed invention acts as a supplement to an existing SCM in a software development project providing project-management-related functionality thereby enabling software developers to carry out project management related tasks in a manner that is closer to their workflow and work environment.

### TECHNICAL FIELD

The present disclosure generally relates to improved systems, methods and software in the field of software project management systems (“PMS”). The disclosure more particularly relates to a system that supplements the capabilities of source-code management systems (such as git) with functionality for software project-management in a way that fits software developers' workflows.

### PRIOR ART

Bhogal et al. U.S. Pat. No. 7,454,744 B2
Pechacek et al., U.S. Pat. No. 11,379,222 B2
Koshelev et al. U.S. Pat. No. 10,956,309 B2
Baker et al. U.S. Pat. No. 10,970,114 B2.
Mansour et al. U.S. Pat. No. 11,238,383 B2
Morgan et al. U.S. Pat. No. 11,205,146 B2
Sims et al. U.S. Pat. No. 10,970,314 B2

### BRIEF DESCRIPTION OF THE DRAWINGS

FIG. 1A is a high level diagram of the involved modules, users, computers and their interconnections

FIG. 1B is a diagram illustrating how a user interacts with an SCM through a client computer.

FIG. 2A is an illustration of a user interface allowing a user to confirm or dismiss messages about to be delivered to recipients.

FIG. 2B is an illustration of a visualization of an interactive commit graph embedded in a user interface

FIG. 2C is an illustration of a user interface allowing developers to chat

FIG. 2D is an illustration of a user interface allowing the selection of branches for rendering in a commit graph visualization

FIG. 2E is an illustration of a user interface allowing a user to configure various directory services.

FIG. 3 shows an overview of various connected systems.

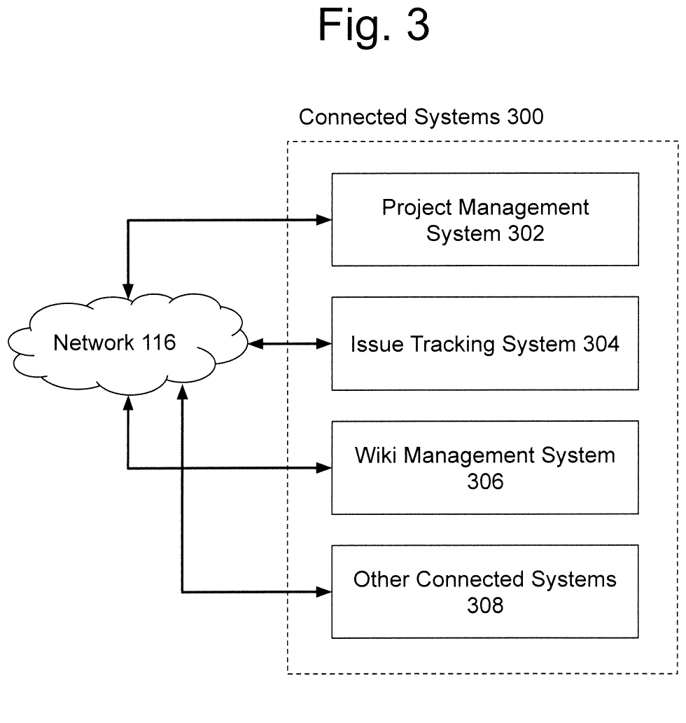

FIG. 4 is a flow chart illustrating the flow of events through the Commenting Module and the SCM Extension Module

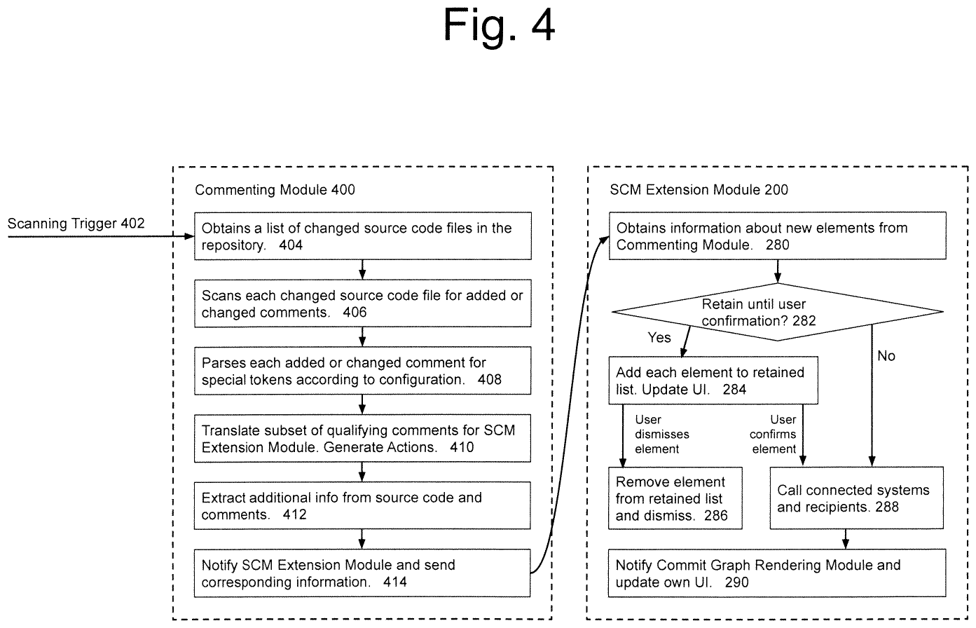

FIG. 6 is a diagram of a computer architecture

FIG. 7 is a high level chart providing an overview of steps in an exemplary use case

FIG. 8A depicts a source code comment that has been augmented with specific tokens.

FIG. 8B depicts a source code comment that has been augmented with specific tokens.

FIG. 8C depicts a source code comment that has been augmented with specific tokens.

FIG. 9 shows a table of example mappings of tokens and keywords to actions.

FIG. 10 shows more example comments and their intended events and actions.

FIG. 11 illustrates an example use case.

### DETAILED DESCRIPTION

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “correlating”, “prescreening”, “developing”, “presenting”, “deploying” or the like, often refer to the actions and processes of an electronic computing device/system, such as a desktop computer, notebook computer, network server, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

The present disclosure assumes the definitions of “developer”, “source code”, “code feature”, “body of source code” and “coarse-grained feature” from the teachings of Bhogal et al. section 008. In addition, “developer” also encompasses non-person actors such as automated systems or AIs that generate, annotate or comment on source code. The term “developer” in the context of this document most generally means anyone or anything interacting with source code. In addition “source code” is also defined to encompass human-readable files related to software or systems development, for example configuration files, dictionary files, CSVs and other similar files.

In the present disclosure we adopt the definitions of “branch” and “commit” from the teachings of Pechacek et al. section 8.

It is noted that the terms “fork” or “forked” in the present disclosure mean the creation of a new sub-branch of development from a certain point on a parent graph in general, even though the terms “fork” or “forked” have a special and somewhat different meaning in the popular git SCM system.

The term “storage media” as used herein refers to any non-transitory media that stores data and/or instructions that cause a machine to operate in a specific fashion.

In the present context the term Issue Tracking System (or short “ITS”) means any commercial or non-commercial or open-source issue tracking system, such as JIRA™ by Atlassian, Bugzilla, GitLab™ or the one disclosed by Pechacek et al.

### Description Outline

In the following description, for the purposes of explanation, numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

While the invention is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the spirit and scope of the present invention as defined by the appended claims.

Embodiments are described in sections according to the following outline:
1. DETAILED BACKGROUND
2. OPERATIONAL OVERVIEW
3. EXAMPLE COMPUTER SYSTEM IMPLEMENTATION
4. SOURCE CODE MANAGEMENT SYSTEMS
5. CODE COMMENTING MODULE
6. SCM EXTENSION MODULE
7. COMMIT GRAPH RENDERING MODULE
8. CONNECTED SYSTEMS
9. MODULE COMMUNICATIONS
10. GENERAL PRINCIPLES

### 1. Detailed Background

A modern SCM, such as git or Mercurial, provides software developers with a structured workflow to modify existing software (extend, change, bugfix, etc. . . . ) that helps keep the integrity and quality of the released software product intact.

In particular an SCM allows a developer or team of developers to modify software code and other assets on a new “branch” of development that branches off an existing, trusted, branch of the software. The feature/bugfix/etc. is then developed on the new software branch and typically QA systems and processes are put in place (such as code reviews, unit tests, etc. . . . ) that the new branch has to pass before it can be merged back into a more trusted software branch (Koshelev et al).

Moreover, SCMs provide the ability to update any branch with new developments from another branch, without affecting the other branch.

SCMs provide an organized model for distributed software development but as a consequence a software codebase no longer has one common state because developers may create an arbitrary number of sub-branches (and sub-sub-branches, etc.) to develop features, integrations, bug fixes, etc. and each such branch will be in a different state, depending not only on the developments that were made on the branch, but also on which point of which source branch it was branched off of and which other branches were merged into the branch to keep it updated.

Each developer may therefore be working on a number of branches, each of which has a different state (in terms of product features, unfixed issues, etc.).

Not least because of this complexity SCMs traditionally do not concern themselves with higher-level project management functions, such as managing issues, tickets, the status of feature requests, etc. As a consequence, to perform basic project-management-related tasks, such as maintaining TODO lists, communicating with and assigning tasks to team members, or documenting progress, developers often fall back to ad-hoc workarounds that are native to their workflow, such as code comments, SCM commit messages or disconnected documents. Those workarounds typically remain invisible to actual project management systems that were put in place by management.

Typical commercial project management software (e.g. Trello by Atlassian, Notion by Notion Labs Inc, Asana by Asana Inc. or the one described by Morgan et al.) on the other hand is top-down. Feature requests, issue tickets, planning timelines and similar things are created as they arise from the use of the software product, users' feedback and management decisions, and updated as the corresponding software modification task progresses towards completion. However the actual process of software modification, as carried out by the assigned software developer(s) (including creating new branches, working on them, merging in other branches, going through various QA processes), is often not reflected in project management software even though that would often help better understand the state of the project. Project management software typically does not concern itself with the details of different states of an SCM as described above. As a workaround such process and state details are “linked to” the request/ticket as comments, files, tags etc. requiring specific compliance from software developers as carrying out such project management functions is not core to their workflow. One such system of attaching data retrieved from an SCM to an ITS is Pechacek et al.

In many cases of software development projects, the SCM-based management solutions that software developers use and the top-down PMS mandated by company management exist and run in parallel, each catering to the needs of different project stakeholders (developers vs. users/managers), each missing to provide real benefit to the other group of stakeholders that it doesn't cater to and each failing to track the process of software development as a whole.

Due to this bifurcation and the organization of most companies it is often required from software developers to carry out certain project management related functions using PMS that are not core to their workflow, thus leading to increased inefficiency and potentially unsatisfactory results.

### 2. Operational Overview

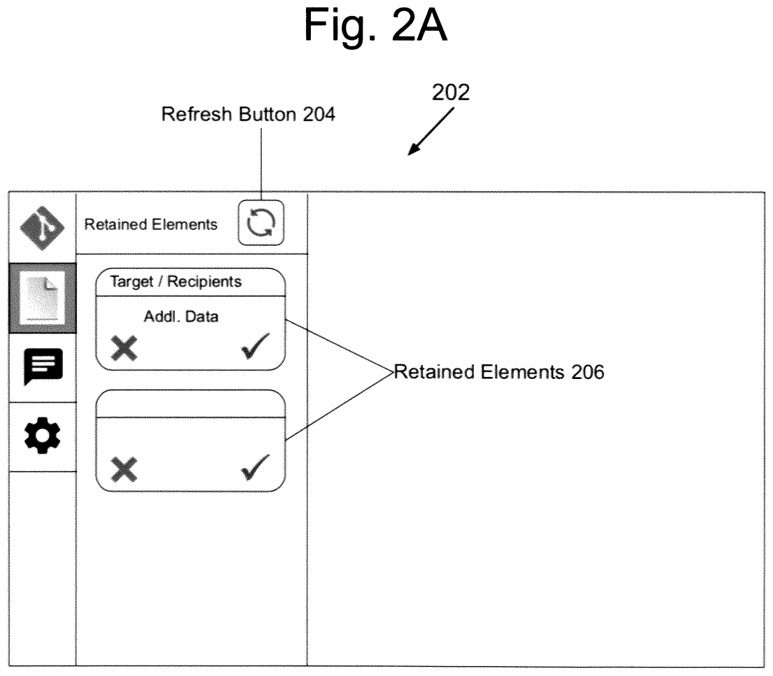

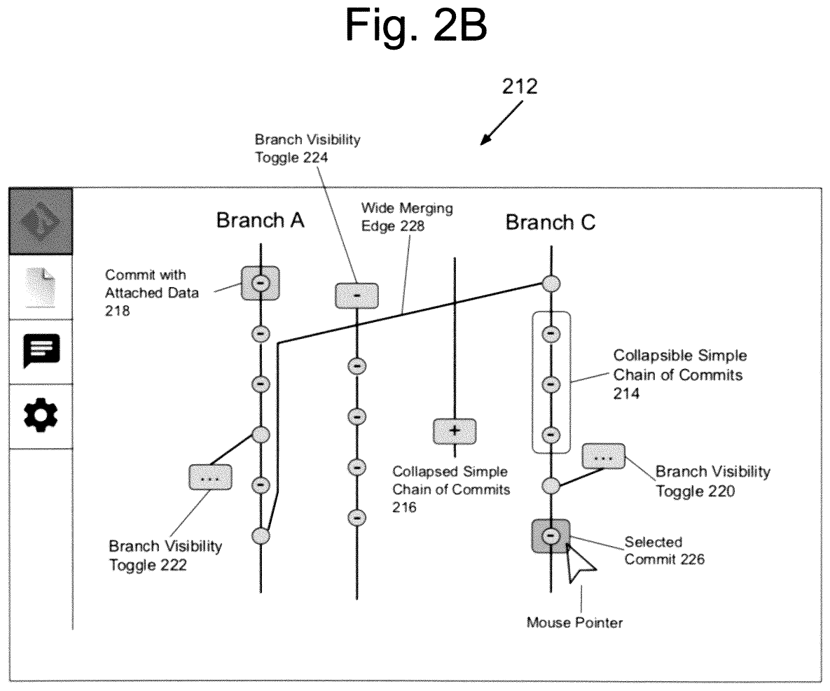

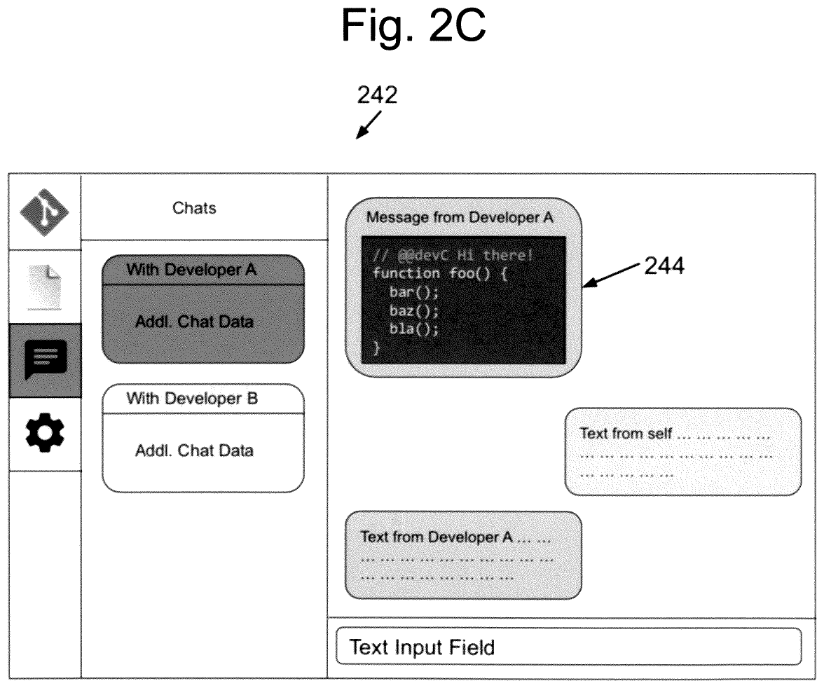

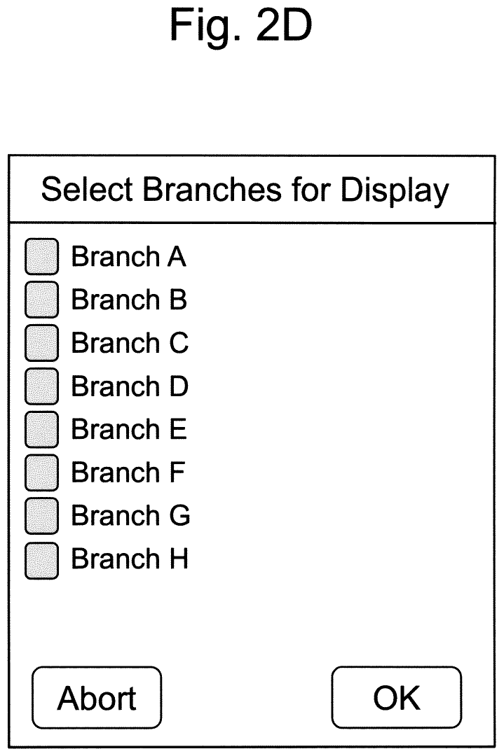

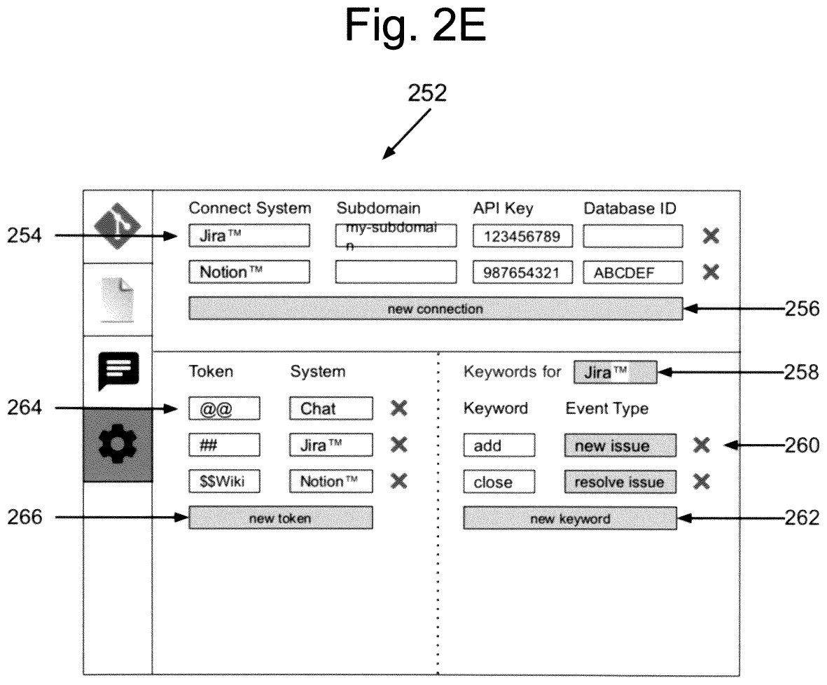

In an embodiment the SCM Extension Module 200 can be configured, for example by the developer 102, a system administrator or any other person with due authorization, to connect to one or more external systems encompassed in the group of Connected Systems 300, for instance a Project Management System 302, an Issue Tracking System 304 or any other compatible system offering an API 350 for integration, as exemplified in FIG. 2E: In a configuration interface 252 pertaining to a directory service the authorized user may add a new connected system 256 or edit an existing connection 254.

As a consequence of established connections the Connected Systems 300 become available as callable event handlers.

Examples of events delivered to connected systems include: Opening, modification and closing of tickets in an Issue Tracking System 304; addition or modification of a Wiki entry in a Wiki management system 306; Addition, modification and closing of work items in a project management system; Update of progress status in a progress tracking system; events of custom nature delivered to a suitably configured API gateway.

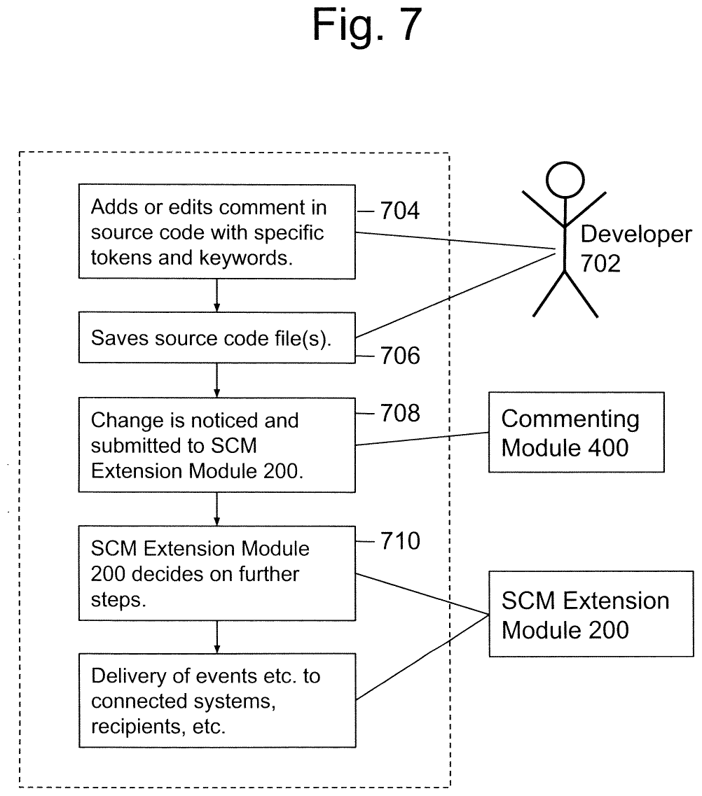

In an example use case illustrated in FIG. 7 a Developer 702 is using one or more interfaces on a Developer Computer to add or edit a textual comment to a piece of source code (704). The developer may optionally provide a range of the source code that the comment applies to or associate a comment with a source code feature in a body of source code being edited or examined by the developer. In the example the developer further augments their comment with specific tokens and keywords pursuant to their goal of delivering a desired event or message to one or more targets or recipients specified in the comment (704). The developer saves the source code file (706), causing the newly added or edited comment to be noticed, picked up and processed (708) by the Commenting Module 400 which subsequently submits it as a processed element to the SCM Extension Module 200. The SCM Extension Module may then take suitable action to deliver the desired event to the suitably configured desired targets from the group of Connected Systems 300 or deliver the desired message or notification to the specified recipients, or decide to dismiss the element.

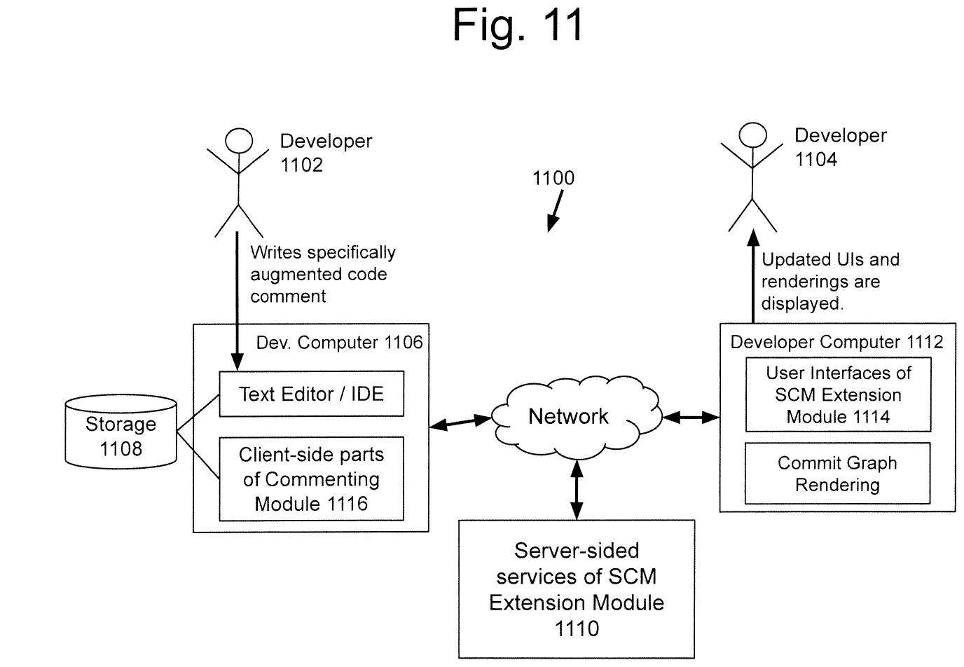

Another example use case is illustrated in FIG. 11: a Developer 1102 is using one or more interfaces on a Developer Computer 1106 to add or edit a textual comment to a piece of source code (704). As in the previous example the developer 1102 may optionally provide a range of the source code that the comment applies to or associate a comment with a source code feature in a body of source code being edited or examined by the developer 1102. The developer 1102 further augments their comment with specific tokens and keywords pursuant to their goal of delivering a message to a recipient developer 1104. The developer 1102 saves the source code file, causing the newly added or edited comment to be noticed, picked up and processed by the Commenting Module 1116 which subsequently submits it as a processed element to the SCM Extension Module 1110. The SCM Extension Module 1110 may then take suitable action to deliver the desired message to the respective recipient developer 1104 through its client-sided user interfaces 1114 running on developer computer 1112 and/or cause the CGRM 500 to produce an updated rendering of the commit graph displayed on the developer computer 1112.

An example UI showing such message delivery is shown in FIG. 2C.

Any interface to source code editing may be used to create the comment including, but not limited to, text editors, IDEs, word processors and web applications, as well as direct modification of the source code by an automated system or AI. Any means of associating the comment with a section of the source code may be used, including, but not limited to, adding specific tokens to the comment that identify the section and selecting the code section in a programmable IDE or code editor that allows for an integration with the Commenting Module 400.

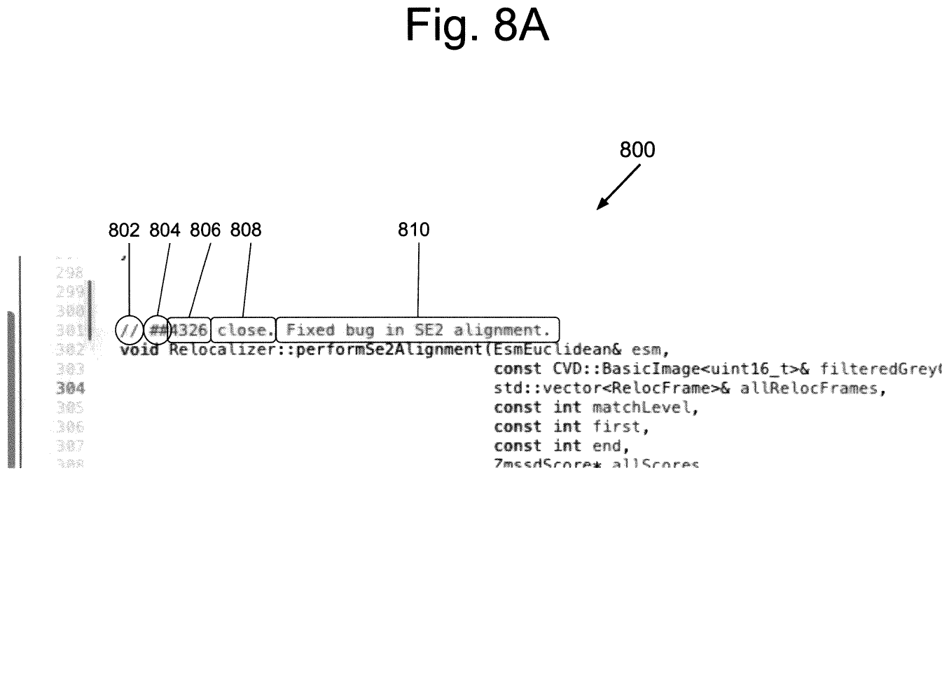

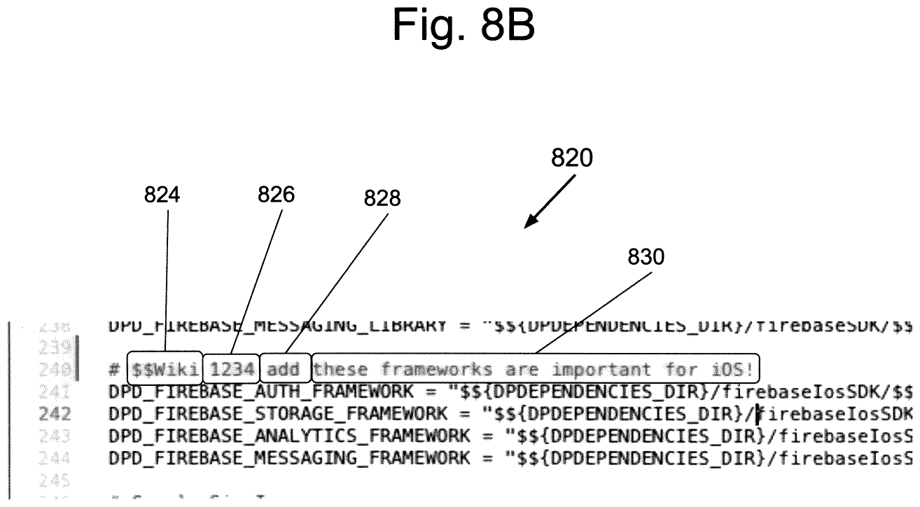

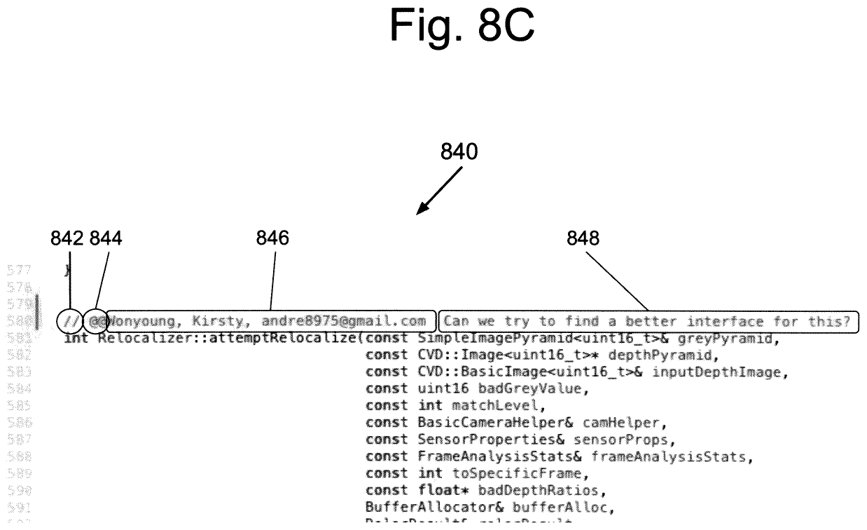

The embedding of events and payloads for Connected Systems 300 in a comment is accomplished through the use of designated tokens. In an example 800 illustrated in FIG. 8A a comment is disambiguated from regular source code by its comment syntax of two leading forward slashes “//” 802, and in an embodiment a particular issue in a connected ITS 304 is targeted by the use of its Issue or Ticket ID 806, preceded by a double-hash token “##” 804 to indicate targeting the connected ITS 304 as the event handler. In the example 800 the comment indicates the resolution of an issue by a code change that the comment refers to, by inclusion of the keyword “close” 808 in the comment. Additional context is given by the developer through the comment text 810.

In another example 820 illustrated in FIG. 8B in an embodiment a comment is made to cause the addition of a Wiki entry with the ID 1234 (826) and the example content 830 in a connected Wiki management system 306 by the use of the “$$Wiki” token 824 and the keyword “add” 828 in the comment.

The Developer 102 may optionally specify recipients in an added or edited comment. The specification of recipients in a comment is achieved through the use of designated tokens. The identification of recipients is accomplished through the use of suitable identifiers for the recipients. Suitable identifiers may include unique usernames of registered developers in the SCM Extension Module 200, email addresses, user handles in messaging services and other identifiers. In an example 840 illustrated in FIG. 8C certain recipients 846 are targeted by the use of their ID, preceded by a double-at token “@@” 844 to indicate targeting the specified recipients as receivers of the added or edited comment 848.

The specified recipients are then notified of the newly added or edited comment by the SCM Extension Module 200 on behalf of the Developer through suitable communication channels including, but not limited to, email, SMS, chat and other messaging services.

The use of forward slashes as comment syntax is for example only and the disclosed invention is not limited to, or in any form dependent on, that particular source code commenting syntax and embodiments of it may support many other kinds of comment formats.

In an embodiment a message is sent to notified recipients by the SCM Extension Module 200 on behalf of the Developer that contains the newly added or edited comment alongside a section of the related source code (244) and is displayed on each of the notified recipients' developer computers through a user interface provided by the SCM Extension Module 200, as illustrated in FIG. 2C.

Most SCMs allow the compilation of code changes into a building block called a “commit”, which is submitted by the developer 102 to the SCM 100 and subsequently managed and archived by the SCM 100. Most SCMs allow developers to attach a written message and/or commentary to a commit, called the “commit message” 124.

In another example use case a developer 102 compiles a set of source code changes as a commit using the SCM and, while doing so, is attaching a commit message 124 containing specific tokens and keywords pursuant to their goal of delivering a desired event or message to one or more targets or recipients specified in the commit message 124 in the same way those events, messages or notifications could be delivered through the use of tokens and keywords embedded in a source code comment as described and exemplified in 800, 820 and 840. The developer submits the commit to the SCM, causing the newly added commit to be noticed, picked up and processed by the Commenting Module 400 in similar ways a newly added and augmented comment would be picked up and the Commenting Module may subsequently take corresponding similar actions.

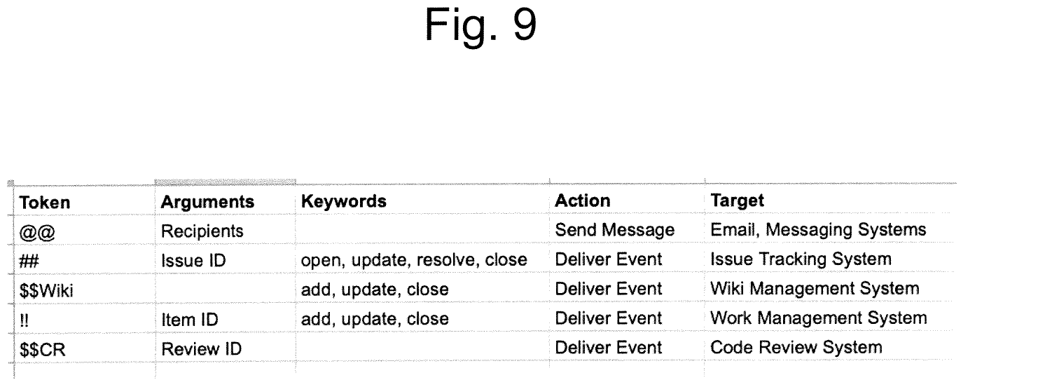

Example mappings of tokens and keywords to actions are given in FIG. 9.

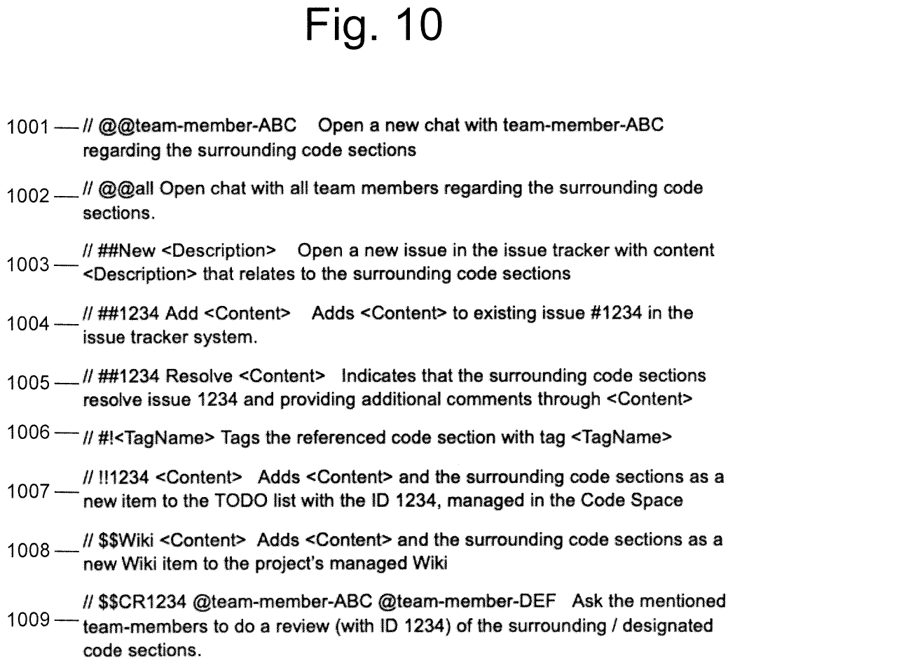

More example comments and their intended events and actions are given in FIG. 10.

It is important to note that the used set of tokens and keywords as well as their associated actions in the provided examples is for example only and by no means exhaustive or fixed and the disclosed invention allows for a virtually unlimited amount of configurations of tokens, keywords, events, recipients and Connected Systems.

In a preferred embodiment the exact tokens and keywords used to trigger events delivered to Connected Systems 300 or to target specific message recipients are configurable, for example by the developer 102, a system administrator or any other person with due authorization, in the Commenting Module 400 which offers a suitable user interface for this purpose. This is exemplified in FIG. 2E: in a configuration interface 252 pertaining to a directory service the authorized user may set up new special tokens 266 or configure existing tokens 264 or configure keywords for a connected system 258 or add new keywords for a connected system 262 or edit existing keywords 260.

In an embodiment source code comments which have been augmented by the usage of designated tokens and keywords as previously described and picked up and processed by the Commenting System 400 and the SCM Extension Module 200, as described in more detail below, become an input to the Commit Graph Rendering Module (CGRM) 500 whose task it is to visualize the interconnected chain of commits from an SCM as an interactive graph that allows users to explore the structure of the SCM as well as various events attached to the commits, and thus the status of the software development project, in a swift and natural manner.

In an embodiment the interactive visualization produced on the Developer Computer 112 by the CGRM 500 acts as a user interface 212 that allows a developer to perform various actions on commits and branches, including, but not limited to: adding a textual comment or question to a commit or branch; attaching one or more files to a commit; visually linking the commit with another commit; expanding or collapsing a branch in the visualization; showing or hiding a branch in the visualization.

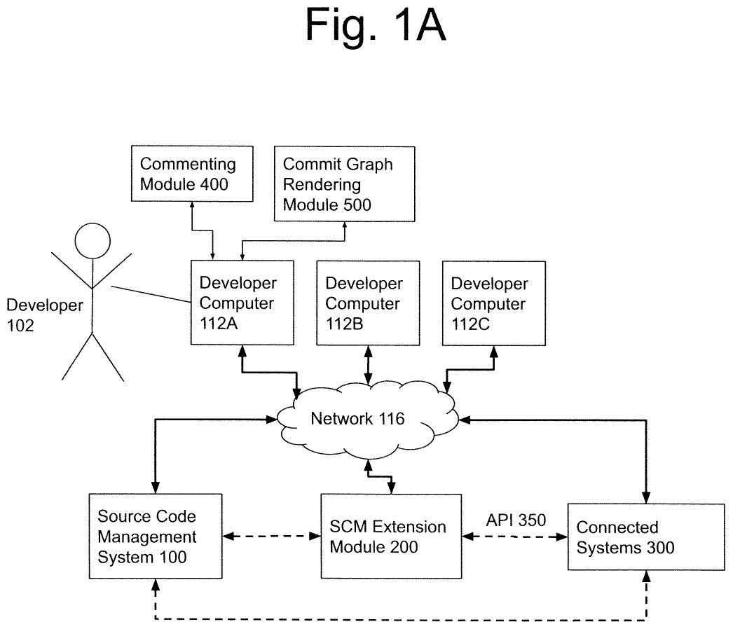

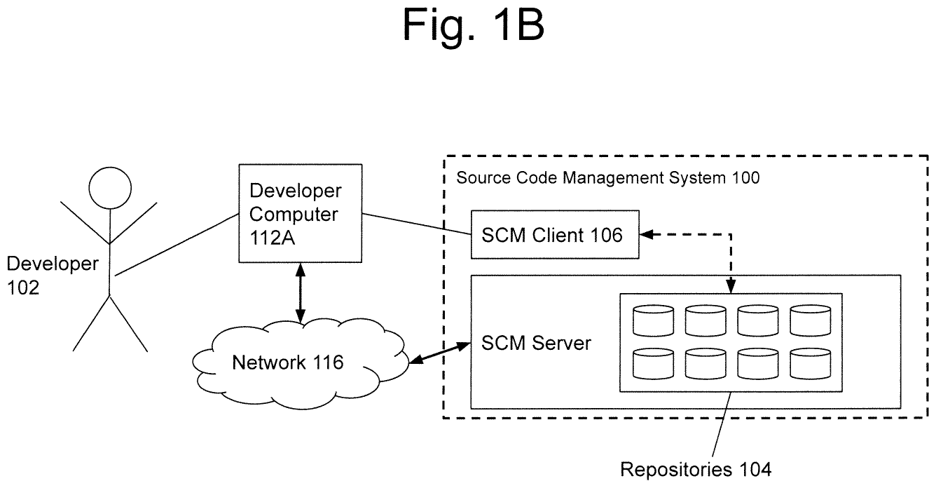

The notification and messaging of recipients, the delivery of events to Connected Systems 300 and the provision of necessary information to the CGRM 500 is carried out through the SCM Extension Module 200, which will be described in more detail below. Those skilled in the art will appreciate that the SCM Extension Module 200, even though illustrated in FIG. 1A as a server-sided part, should be understood as a general mechanism and that the present disclosure is not constrained by or limited in scope depending on where in a network of computers those mechanisms are actually deployed.

Other embodiments, aspects and features will become apparent from the disclosure as a whole.

### 3. Example Computer System Implementation

At a high degree of generality FIG. 1A illustrates the systems involved in implementing the various embodiments described herein. In broad terms, the embodiments include an SCM system 100, an SCM Extension Module 200 and various other Connected Systems 300 as well as developer computers 112A, 112B and 112C being in communication with the Commenting Module 400 and the Commit Graph Rendering Module 500. The chosen number of developer computers in this example is arbitrary and the function of the disclosed system is not in any way affected by the number of client computers connected. Further details on the systems are provided below.

Systems 100, 200, 300, 400 and 500 provide their respective services to user computers 112, over a network 116, or through other suitable means of data exchange, for example direct execution of the service on the user computer. Although illustrated as different entities, skilled addressees will recognize that in certain embodiments SCM 100 could also be part of one of the Connected Systems 300, for example as part of an integrated commercial offering, bundling, for instance, SCM 100, ITS 304, Wiki 306 and potentially other systems as one offering (e.g. GitLab™). Although the connection between the SCM Extension Module 200 and the SCM 100 and Connected Systems 300 is illustrated as a network connection, such connections could as well be implemented at a locally-hosted computing facility or using distributed, cloud-based data center infrastructure. Depending on the implementation environment, Network 116 can be a local area network, intranet or the Internet.

SCM system 100 maintains repositories 104 of source code files and other materials pertaining to individual software development projects and are described in more detail below.

In addition to communicating with user computers 112, SCM 100 and other Connected Systems 300 are also in communication with each other, either directly, as part of built-in functionality provided by these systems, or by way of the SCM Extension Module 200, which is described in more detail below. The SCM Extension Module 200 is illustrated in FIG. 1A as a unit that is separate to SCM 100 and other Connected Systems 300. However, skilled addresses will realize that in certain embodiments the module could be integrated either at the software or hardware level into the SCM 100. Communication between the systems occurs over network 116 or other suitable channels depending on the respective network locations of the systems.

As described in further detail in other parts of this document, the present embodiment involves operating the SCM Extension Module 200 to retrieve development status information from the SCM system 100, comment- and event-related information from the Commenting Module 400, other information from Connected Systems 300 for processing and storage, and element selection information from the CGRM 500, to provide results to the CGRM 500 and back to the Connected Systems 300. The CGRM 500 processes all its retrieved information according to a display methodology described in more detail below and into a form suitable for display on a developer computer 112. The Connected Systems 300 may react to information retrieved from the SCM Extension Module 200 by way of their APIs in the manner they were designed to.

Those skilled in the art will recognize that embodiments may implement client- or developer computers 112 as physical machines or virtual machines and that the present disclosure is not limited to either choice.

### 4. Source Code Management System

Developers interface with the SCM to organize, archive and make their primary work output (source code, documentation etc.) available to their organization. At the highest level an SCM manages a number of source code repositories 104, as shown in FIG. 1B. Each repository contains the current state of a part, or of the entirety, of a software development project, depending on the project. It also contains the complete history of states, organized as a graph 120 of discrete interconnected units of code changes, called Commits 122. Software developers typically interface the server-sided part of the SCM 100 through their computers over a network.

Each client developer computer typically has a local copy of each relevant source code repository on its hard drive.

During development, developers typically organize coherent code changes into Commits 122 which then get sequenced into chains of Commits on a development Branch 130. Forming such sequences of commits may happen on the local repository copy on the developer computer and the developer may choose to synchronize the server-sided version of the repository with the client-side copy at suitable times. The developer may also carry out work to modify the repository through an interface delivered through a network that enables the developer to modify the server-sided version of the repository directly without involving a local copy. The disclosed invention is not limited to either fashion. Skilled addressees will further recognize that operations on the SCM 100 are therefore not limited to operations that happen directly to the server-sided part of the SCM 100 but instead may be comprised of operations on a local copy of a managed code repository that may or may not get synchronized back to the main server-sided repository.

Developers can perform various actions related to a repository that trigger events in the SCM system. These events, along with other essential information required by the SCM system to record modifications to the source code files and track the project's development progress, are stored in the repository.

SCM systems typically offer APIs for integration with other systems and modules.

For more detailed information about SCMs the reader is referred to suitable public literature on the topic as well as the disclosures of Koshelev et al.

### 5. Code Commenting Module

The Commenting Module 400 performs the following functions: scanning files in a source code repository for new or edited comments 406 and, upon finding new or edited comments, distinguishing the comments from the executable source code; parsing the comments for specific tokens and keywords 408 and, if necessary, translating those tokens and keywords into actions that the SCM Extension Module 200 can understand and act upon 410; extracting data payloads from the parsed comments necessary for the execution of certain events and gathering one or more sections of source code that the comments may be referring to 412; corresponding with the SCM Extension Module 200 about the added or edited comments, their actions, contents and their embedded events and payloads 414.

In addition the Commenting Module 400 may be in correspondence with the SCM 100 receiving events pertaining to the addition of commits to the SCM. The Commenting Module 400 may perform the following additional functions: Upon noticing a new commit, parsing its commit message and then performing generally the same steps as for newly added or edited comments.

Certain embodiments may choose a slightly different order of steps wherever those steps are not dependent on each other.

At a high degree of generality the Commenting Module 400 can be understood as a client-sided system that performs functions related to the parsing of source code and SCM commit messages 124 on the developer computer 112. However it will be noted that certain embodiments may choose to deploy the Commenting Module as part of a web application and as such providing certain services of the Commenting Module 400 on a server computer instead of on the developer computer. For example the parsing, gathering, translating, extraction and corresponding steps outlined above may each be executed on one or more server computers serving a developer computer client.

In an embodiment the Commenting Module 400 may be configured to monitor a hierarchy of folders that are part of the managed copy of a source code repository on the Developer Computer for changes in files at a regular user-configurable time interval.

In an embodiment the Commenting Module 400 is connected to the developer computer operating system in a way that enables receiving programmatic callbacks from the operating system whenever a change is detected in a monitored hierarchy of folders that are part of the managed copy of a source code repository on the Developer Computer 112.

In an embodiment the Commenting Module 400 provides GUI or command-line facilities to the user on the developer computer 112 to configure and control the triggering of the scanning of the source code for new or edited comments, such as a CLI or a “refresh” button 204, as illustrated in FIG. 2A.

The scanning of the source code for new or edited comments may be triggered 402 in one or more of the following ways: At regular, user-configurable time intervals; Upon detection and reporting of a code change by the part of the SCM that is running on the Developer Computer; Upon detection of a change in one or more of the files that are part of the monitored hierarchy of folders by the Commenting Module; upon detection and reporting a change in the monitored hierarchy of folders by the operating system on the Developer Computer 112; Upon receiving an event from a text editor or IDE that the Commenting Module is plugged into; Upon a specific user-operated trigger, for example a button press or a CLI command; in a combination of the afore-mentioned ways.

In an example a developer adds a new source code comment, augmented with suitable special tokens and keywords, to a source code file and saves the source code file. The operating system running on the developer computer 112 monitoring the hierarchy of folders that the source code file is contained in notices the change on the file system and delivers a corresponding message to the Commenting Module 400 which then processes the source code files as described.

In another example a developer adds a new source code comment, augmented with suitable special tokens and keywords, to a source code file, saves the source code file and continues with their work. At a suitable time the developer clicks the “refresh” button 204 in the UI provided by the Commenting Module which causes the Commenting Module to process the source code files as described.

In an embodiment the Commenting Module makes use of the SCM client 106 when scanning source code files for added or edited comments.

In a preferred embodiment the Commenting Module 400 offers a configuration interface 252 pertaining to a directory service that allows developers, system administrators and other persons with due authorization to configure the specific tokens and keywords that can be used to augment comments and commit messages for the purpose of delivering events delivered to Connected Systems 300 or messages to specified recipients. An example of such a configuration interface is given in FIG. 2E. The Commenting Module makes use of this configuration when parsing comments and commit messages.

Those skilled in the art will recognize that the Commenting Module 400, even though illustrated in the presented Figures as one self-contained module, should be understood as a general mechanism and that embodiments may choose to implement the Commenting Module 400 as a connected set of services, libraries, plugins, daemons and applications. By way of example the file system monitoring part of the Commenting Module may be implemented as a background “daemon” app running natively on the Developer Computer while other parts of the Commenting Module may be implemented as the client-sided part of a web application or as a plugin to an IDE or text editing application running on the Developer Computer.

Those skilled in the art will further recognize that certain parts or all of the Commenting Module may be provided as a service over a network by a network-connected computer, as opposed to running locally on the Developer Computer.

Those skilled in the art will further recognize that more than one developer computer 112 may make use of the Commenting Module, each developer computer 112 making use of an independent instance of the Commenting Module, even though the configuration illustrated in FIG. 1A shows the Commenting Module as connected to only one developer computer.

In an embodiment the Commenting Module 400, or certain parts of it, provide their services through a plug-in mechanism that allows an integration with third-party text editors, IDEs and the like.

In another embodiment the Commenting Module 400, or certain parts of it, provide their services through a web application.

Those skilled in the art will further recognize that the Commenting Module is independent of the tools used to make changes to the source code or comments.

### 6. SCM Extension Module

The disclosed invention requires the processing, management and storage of data relevant to a software development project. A subset of this data, in particular data that is not already made available by the SCM 100 or the Connected Systems 300, is processed, managed, stored and, where necessary, made available, by the SCM Extension Module 200.

Examples of this kind of data are: data pertaining to specifically augmented code comments and commit messages; Other data embedded in code comments and commit messages; User account information; chat histories and other data related to user notifications; data pertaining to comments, questions or files attached to commits; data pertaining to the rendering of the repository commit graph by the CGRM.

In a preferred embodiment the SCM Extension Module makes use of a database 298 to store and manage this data.

In the context of the disclosed invention the SCM Extension Module 200 can be understood as a managing central hub that connects various systems and modules as illustrated in FIG. 1A.

At a high degree of generality the SCM Extension Module 200 can be understood as a set of server-sided services 296 that serve one or more connected clients, such as developer computers 112 and receive information from clients and connect to other server-sided systems and modules, such as the server-sided parts of an SCM 100.

Also part of the SCM Extension Module 200 are various user interfaces 295 offered to developers pertaining to: the triggering and processing of certain kinds of events 202; module configuration 252; chat functionality 242; user account management; interactive commit graph visualization 212. Such UIs are displayed on the developer computer 112 and thus on the client side. Their inclusion in the SCM Extension Module 200 in the present disclosure is due to their functional and data-related proximity rather than architectural proximity.

In an embodiment the user interfaces of the SCM Extension Module 200 are delivered through a web application that can be accessed through a web browser.

In another embodiment the user interfaces of the SCM Extension Module 200 are delivered through a standalone application that is executed directly on a developer computer 112.

A main function of the SCM Extension Module 200 is the provision of key data and services required for the operation of the disclosed invention, including: reception of data pertaining to newly added or modified source code comments from the Commenting Module 400, including their actions, contents and their embedded events and payloads; delivery of events and event payload data to Connected Systems 300 through their respective APIs; delivery of notifications and messages to recipients, retrieving data from the SCM 100 pertaining to a software development project and its source code repositories; storing and serving various data created throughout the operation of the disclosed invention; providing necessary data to the CGRM 500; retrieving data from the CGRM 500 pertaining to the user-selection of drawn elements; providing interfaces to developers for usage and configuration.

The SCM Extension Module 200 responds to requests from the SCM 100, the Commenting Module 400, other Connected Systems 300 and the user or developer through the Developer Computer 112.

Systems and Modules contained in the group of Connected Systems 300 may call the SCM Extension Module 200, to which the SCM Extension Module may respond in a suitable manner, for example by providing updated data to the CGRM 500 and by updating its own user interface.

In an embodiment, and exemplified in FIG. 2E, the SCM Extension Module 200 offers a configuration interface 252 pertaining to a directory service that allows the SCM Extension Module to be set up in a way that allows the connection of the SCM Extension Module 200 to Connected Systems 300. Such connections are essential to the delivery of event data as retrieved from the Commenting Module 400.

In a typical sequence of events the Commenting Module 400 calls the SCM Extension Module 200 upon detecting new qualifying source code comments or commit messages as described, and the SCM Extension Module 200 responds: by delivering (288) events, messages and notifications to Connected Systems 300 and specified receivers where suitable; by providing updated data to the CGRM 500 and by updating its own user interface (290).

The SCM Extension Module 200 can be further configured to retain 282 data received from the Commenting Module 400, the SCM 100 or the Connected Systems 300 and delay the delivery of associated events, messages or notifications until manual user confirmation, which happens through a suitable user interface. In an embodiment, and exemplified in FIG. 2A, the SCM Extension Module 200 contains such a user interface 202 that shows a list of such retained elements 206 to the user for further inspection. For each element displayed in the list the user is able to either confirm the element, causing the delivery of associated events, messages or notifications, or dismiss the element, causing the element to be removed from the list and corresponding events, messages etc. to not be delivered.

In an embodiment the confirmation or dismissal of retained elements is possible through a programmatic interface, such as an API exposed to a network or socket-driven communication or inter-process communication.

The CGRM 500 may call the SCM Extension Module 200 upon having an updated set of user-selected elements of the drawn commit graph and the SCM Extension Module 200 may query the CGRM 500 for such an updated set. The SCM Extension Module 200 may respond to such an updated set by updating its own UI.

In an embodiment the SCM Extension Module 200 delivers a service and user interface 242 to connected computers that allows developers to chat with each other, for example in response to sending or receiving specifically augmented code comments or commit messages. An example user interface is shown in FIG. 2C.

In an embodiment code comments augmented with recipient data, for example code comments structured as in the example 1001, that were parsed and processed as described, deliver a message to the recipient containing the comment as well as surrounding areas of code (244), as exemplified in FIG. 2C.

In an embodiment the SCM Extension Module 200 delivers a service and user interface to connected computers that allows users to select specific branches of a managed source code repository for rendering by the CGRM 500. Branches that are not included in the selected set are not rendered in the same way as selected branches, or not rendered at all, by the CGRM 500. An example user interface dialog is shown in FIG. 2D.

In an embodiment the SCM Extension Module 200 embeds the interactive visualization of the commit graph, as produced by the CGRM 500, in a user interface 212 delivered to connected computers.

Those skilled in the art will recognize that the SCM Extension Module 200, even though illustrated in the presented Figures as one self-contained module, should be understood as a general mechanism and that embodiments may choose to implement the SCM Extension Module 200 as a connected set of services, libraries, plugins, daemons and applications. By way of example the user interfaces pertaining to the commit graph rendering 212, retained element selection 202, chat functionality 242 and module configuration 252, may be implemented as browser-sided web applications through the use of client-side languages such as Javascript whereas other parts of the SCM Extension Module 200, such as the mechanism to deliver events to Connected Systems, may be implemented in a separate and purely server-sided fashion.

Those skilled in the art will further understand that embodiments may choose to implement the SCM Extension Module 200 and the CGRM 500, even though illustrated as separate modules in the present disclosure, as a combined module if such combination is advantageous, and that the distinction between the two modules in the present disclosure is one based on function and services provided, rather than one based on location or proximity of these functions and services in a computer network.

### 7. Commit Graph Rendering Module

### Background and Overview

During the development of software, developers typically organize coherent source code changes into entities called “Commits” which then get sequenced into chains of Commits that can be used to track the development of the software over time.

An SCM allows a developer or team of developers to structure such chains of commits into “branches” that can be forked from and merged with other branches of development, thus forming a structure called the Commit Graph, as illustrated in FIG. 2B. As a development project and the number of developers on the project grows, so does the complexity of the Commit Graph. In large projects it is not uncommon for a Commit Graph to consist of tens or hundreds of thousands of commits and thousands of branches where any pair of branches may be linked, directly or indirectly, through a fork- or merge-operation.

Commit Graphs provide a valuable abstract high-level view of a software development project because they enable a user to track which member of a development team is working on what, and because the logic of commit, fork and merge operations allows a user of the Commit Graph to draw conclusions about the state of the software on any particular branch, especially with respect to software features as well as open or fixed issues.

Unfortunately the complexity of commit graphs in large projects makes their visualization very challenging as the number of interrelated elements displayed can quickly outpace a human's ability to comprehend structure visually, which makes Commit Graphs a generally underused tool in project management.

On a high level the Commit Graph Rendering Module 500 is concerned with: visualizing the Commit Graph 212 in a fashion that reduces visual complexity and thereby allows human users to comprehend the high-level structure and relationships in the Commit Graph; visually embedding user-generated metadata, including textual comments or questions attached to commits or branchs, files attached to commits or branches and links between commits or branches; and providing interactivity to the visualized commit graph by providing mechanisms to retrieve and make available individual elements of the drawn commit graph in response to user interaction with the drawn element.

### Description

In the following the term “simple chain of commits” or just “simple chain” refers to a sequence of commits in which each commit has exactly one parent commit and one child commit, where the sequence contains at least two commits.

The CGRM receives data from the SCM 100 and the SCM Extension Module 200 and produces an interactive visualization of the Commit Graph 212 of a source code repository for display on the Developer Computer 112.

Data received from the SCM 100 includes: the graph of commits of a source code repository including, but not limited to, the commits' dates, authors 126, messages 124, SHA codes 128, tags, branch pointers 130 and connections; a list of open “pull requests”; the repository's list of “remotes”.

Data received from the SCM Extension Module includes: a set of identifiers of user-selected branches for visualization; Metadata for specifically augmented code comments and commit messages; Other data embedded in code comments and commit messages; User account information; Chat histories and other data related to user notifications; Data pertaining to comments, questions or files attached to commits; data pertaining to the collapsing and expansion of chains of commits in the visualization.

The rendering of the Commit Graph by the CGRM is performed as the following series of steps:

In the first step the CGRM receives a set of identifiers of user-selected branches for visualization from the SCM Extension Module 200 and data from the SCM pertaining to commits of the user-selected set of branches.

In the second step the CGRM receives other data from the SCM Extension Module relating to the selected branches and commits, as described above.

In the third step the CGRM creates or updates its internal data structures for visualization and ensures that each simple chain of commits will be visually represented collapsed into one special expandable node 216 embedded in the commit graph 212 in lieu of a full drawing of the simple chain of commits, wherever the user or the CGRM has decided to apply such a collapse.

In the fourth step the CGRM determines the X and Y positions of each node in the rendering where generally each commit is represented by one node, except for commits on simple chains, which may be represented jointly as one expandable node 216.

In the fifth step the CGRM determines the visual positions of drawn elements 218, 220, 222, 224 pertaining to the augmentation of individual commits including but not limited to: comments, questions or files attached to commits; specifically augmented source code comments that were made or updated at a particular commit; issue tickets that were opened, updated or closed at a particular commit; other events that were triggered at a particular commit; starting points of not-selected branches; merge-in points of not-selected branches.

In the sixth step the CGRM draws all the required elements on screen, including commits and their connections as well as augmenting and user interface elements in the graph, using a suitable mechanism for 2D drawing and using its internal data structures and determined visual positions of elements.

Those skilled in the art will recognize that embodiments may choose a different order of steps wherever those steps are not dependent on each other.

A suitable mechanism for 2D rendering may be the web-standard Canvas API, SVG, WebGL, OpenGL, OpenGL ES, PostScript, PDF, software-defined rendering on the CPU or GPU into a provided buffer as well as any higher-level APIs and wrappers built around the aforementioned mechanisms.

In an embodiment the determination of X and Y positions in step four is based on an open-source algorithm, for example the one used in GitX-dev, GitUp, gitamine, gitk, . . . .

In another embodiment, the determination of X and Y positions in step four is based on the efficient solution of a system of X- and Y-delta constraints between the drawn nodes.

In an embodiment specific styles are used to draw edges between commits: Edges with a non-zero X delta (merges, branch-offs) use a special style to make them visually distinct vs. regular edges. Edges with a significant X delta component (e.g. spanning across multiple branches on screen) use a special style to make them less visually disruptive. Edges with a non-zero X delta and a significant Y delta that exceeds a certain threshold are drawn in another special way that distributes almost all of the X delta over a small subrange at the top of the Y delta up to the threshold, keeping the edge visually close to the destination branch, then “kinks” the edge and distributes the remaining Y delta drawing the edge parallel to the source branch of the parent commit node, in a way that resembles a “frontage road” to a highway. This style is illustrated in FIG. 2B where an edge 228 merges from branch A into branch C.

The CGRM 500 also includes suitable mechanisms to retrieve and make available identifiers of individual elements of the drawn commit graph, such as commits, expandable nodes, augmenting elements and the like, in response to user interaction with the drawn element, such as mouse hovers and clicks, selection via keyboard, etc. as exemplified in FIG. 2B, element 226. Upon retrieving an updated set of identifiers the CGRM may call the SCM Extension Module 200 providing the updated set for further processing and display.

Embodiments may choose to include interactive graphical elements in the drawn commit graph where such elements are visually attached to drawn nodes in the commit graph and allow the inclusion 220, 222 or removal 224 of branches from the set of user-selected branches that is used by the CGRM to draw the commit graph.

In a preferred embodiment the rendering of the commit graph takes place on the developer computer 112 as a whole. However skilled addressees will recognize that the rendering or parts of it, for example the determination of element X and Y positions could also take place on a server computer where the inputs and results of such operations would be exchanged via a network connection 116.

It is noted that the graphical illustrations in FIG. 2B are for example only and that embodiments may choose alternative visualizations that honor the general spirit and functionality of this disclosure.

### 8. Connected Systems

Exemplary members of the group of Connected Systems 300 are Issue Tracking Systems (ITS) 304, Wiki Management Systems 306, Project Management Systems 302 and other connected systems such as user account management systems, task scheduling systems, content discovery systems, etc. In general any system offering an API 350 for integration may be included in the group of Connected Systems 300, including custom and fully configurable API gateways.

Most connected systems in use today offer the ability to interface with other systems programmatically through an Application Programming Interface (API). The SCM Extension Module 200 makes use of such APIs to communicate with Connected Systems 300.

In a simplified example of a sequence of events the Commenting Module 400 calls the SCM Extension Module 200 upon detecting qualifying source code comments or commit messages as described (414), and the SCM Extension Module 200 responds by delivering (288) events to Connected Systems 300 where suitable. The Connected Systems 300 may then respond to the delivered events in the way they were programmed to, for example by updating tickets in an Issue Tracking System, adding new pages to a Wiki Management System 306, triggering a webhook, etc.

More learnings about other connected project management systems can be found in the disclosures of Pechacek et al., Mansour et al., Morgan et al., Baker et al. and Sims et. al.

### 9. Module Communications

TODO: Exchange between systems using unique IDs (for issues, commits, etc)

In response to receiving information from the Commenting Module 400, the SCM Extension Module 200 may choose to deliver events and event metadata to Connected Systems 300. This mechanism can be achieved in a number of different ways. As one example, and in certain embodiments, SCM Extension Module 200 is configured to use webhooks that are triggered by the Commenting Module 400 when it suitably decides to. The webhooks are designed to notify the SCM Extension Module by way of an HTTP or HTTPS request to a suitable URL endpoint of the association and provide the SCM Extension Module 200 with details of the specific event. Correspondingly, SCM Extension Module 200 is configured to listen for communications arriving on the designated URL and process and store the provided information. Similarly, by way of example and in certain embodiments, the systems and modules in the group of Connected Systems 300 are contacted by the SCM Extension Module 200 through their APIs, which may, for example, be REST endpoints. In another embodiment the Network 116 is an intranet and the Commenting Module 400 communicates with the SCM Extension Module 200 using suitable intranet identifiers and the SCM Extension Module 200 communicates with the Connected Systems 300 using suitable intranet identifiers.

Connections of the various components and modules in FIG. 1A to the Network 116 may be wired or wireless and those skilled in the art will understand that the present disclosure makes no assumptions about the nature of the connection.

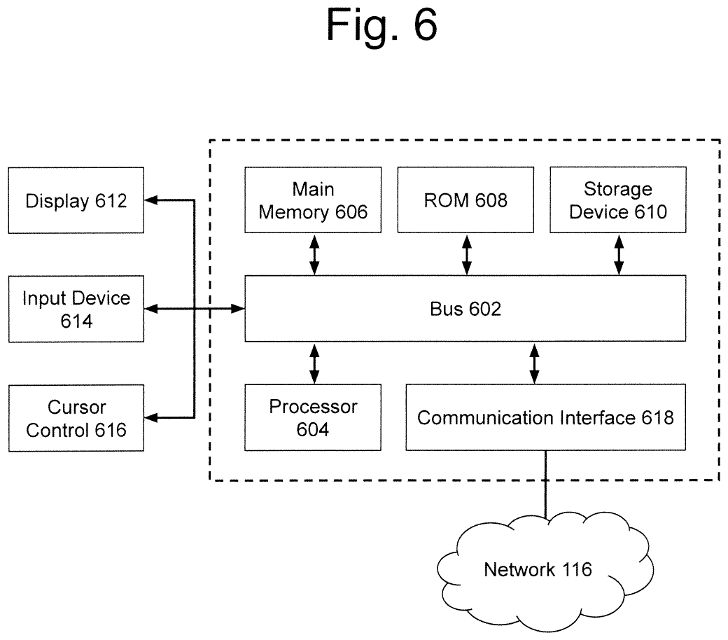

As noted in various parts of this document, the present disclosure also makes use of a Developer Computer 112. The Developer Computer 112 may host certain facilities that enable the operation by a developer user. The Developer Computer 112 may host an SCM client 106 which provides client-side SCM functionality. The Developer Computer is of the kind illustrated in FIG. 6, which is described specifically in more detail in other parts of this document. A display 612 connected to the suitably configured Developer Computer 112 produces displays of information including, but not limited to: the interactive commit graph visualization as produced by the CGRM 500; user interfaces produced by the SCM Extension Module 200; data pertaining to source code repositories as produced by the SCM client 106 hosted on the Developer Computer; A user interface is also displayed on Developer Computers 112 for receiving user input, for example to create new source code comments or to attach information to existing commits.

Client applications running on the Developer Computer 112 may be general web browser applications, such as, for example, Chrome, Safari, Internet Explorer, Opera. In this case the client 114 accesses corresponding servers via an appropriate uniform resource locator (URL) and communicates with the corresponding servers using general world-wide-web protocols, e.g. http, https, ftp. The web browser application is configured to request, render and display electronic documents that conform to a markup language such as HTML, XML or extensions, and may be capable of internally executing browser-executable code such as JAVASCRIPT, VB Script, or other forms of code. Where the ITS client 114 is a web browser, the ITS server 104 will be a web server, such as, for example, Apache, IIS, nginx, GWS.

Alternatively, the Client applications may be specific applications programmed to communicate with servers using defined application programming interface (API) calls. In this case the servers will be specific application servers configured to interact with the client applications.

A Developer Computer 112 may host more than one client application, for example a general web browser client and a specific application client. Similarly, a Server Computer may host more than one Server Application.

A server computer may serve multiple client computers 112. In FIG. 1, three client computers have been depicted 112A, 112B, and 112C, though more or fewer could be used.

A client computer may communicate with zero, one or more server computers at any given time.

The server computer and client computer 112 communicate data between each other either directly or indirectly through one or more communications networks 116. Communications network 116 may include a local area network (LAN) of an enterprise in one embodiment. In this case the SCM 100, SCM Extension Module 200 and any module or system of the group of Connected Systems 300 may be implemented as an on-premises solution in which the server computer and user computer 116 are associated with the same business enterprise and at least the server computer is within an enterprise-controlled facility that is protected from the open internet using firewalls or other security systems. In another embodiment, network 116 may represent the public internet and the server computer may be located off-premises with respect to an organization, such as in a shared data center or cloud computing facility.

While a single server client-server architecture has been described above, the methods, systems, modules, embodiments and features described herein may be implemented using alternative architectures. For example, in certain cases a clustered architecture may be used where multiple server computing instances or nodes are instantiated to meet system demand. Conversely, in the case of small enterprises with relatively simple requirements a stand-alone implementation may be used, i.e. a single computer directly accessed/used by the developer.

### 10. General Principles

While only a few embodiments of the present disclosure have been shown and described, it will be obvious to those skilled in the art that many changes and modifications may be made thereunto without departing from the spirit and scope of the present disclosure as described in the following claims. While the disclosure has been described in connection with certain preferred embodiments, other embodiments would be understood by one of ordinary skill in the art and are encompassed herein.

The methods, systems, modules, embodiments and features described herein may be deployed in part or in whole through one or more special-purpose computing systems or devices. For instance, in FIG. 1A, each of the Developer Computers could be categorized as a type of computing system. Zero, one or more additional computing systems may be used to implement modules 100, 200 and 300, 400 and 500.

A special-purpose computing system can be specifically designed to carry out the required operations. Alternatively, a special-purpose computing system can include digital electronic devices like one or more application-specific integrated circuits (ASICs) or field programmable gate arrays (FPGAs) that are persistently programmed to perform the required operations. Furthermore, a special-purpose computing system may incorporate one or more general-purpose hardware processors that have been programmed to perform the relevant operations based on program instructions stored in, and loaded from, memory, firmware, other storage, or a combination of these, wherein the program instructions may enter and leave the memory, firmware or other storage at suitable times throughout the course of operation of the computing system.

A special-purpose computing system can also integrate customized hard-wired logic, ASICs, or FPGAs with custom programming to accomplish the operations described in this document. Furthermore, a virtual machine implementing, emulating or simulating one or more or parts of the aforementioned computing systems in software can be a special-purpose computing system. A special-purpose computing system can be any device that includes hard-wired and/or program logic to carry out relevant operations, such as a desktop computer system, a portable computer system, a handheld device, a virtual machine, a networking device, or any other similar device.

By way of example, FIG. 2 presents a block diagram that displays a possible configuration of a computer system 600 that could be configured to implement the features and embodiments described in this document. The computer system 600 comprises a bus 602 or other communication mechanism that is employed to transmit information, as well as a hardware processor 604 that is connected to the bus 602 to handle the processing of information. The hardware processor 604 could be a general-purpose microprocessor, a graphical processing unit, or another processing unit.

Moreover, the computer system 600 includes a main memory 606, such as a dynamic storage device or a random access memory (RAM), which is attached to the bus 602 for storing information and instructions that the processor 604 will execute. The main memory 606 can also be used for storing temporary variables or other intermediate information during the execution of instructions by the processor 604. When the instructions are stored in non-transitory storage media that are accessible to the processor 604, the computer system 600 becomes a customized special-purpose machine that is customized to perform the operations specified in the instructions.

Additionally, the computer system 600 has a read-only memory (ROM) 608 or another static storage device that is connected to the bus 602 for storing static information and instructions that the processor 604 will execute. A storage device 610, like a magnetic disk or an optical disk, is provided and connected to the bus 602 to store information and instructions.

If the computer system 600 is a client device 101, the computer system 600 can be connected, through a suitable data connection, to a display 612, like an LCD, an LED, a touch screen display, or another display, to show information to a computer user. An input device 614 that includes alphanumeric and other keys may be linked to the bus 602 to transmit information and command selections to the processor 604. Additionally, another type of user input device, like a cursor control 616, such as a mouse, a trackball, or cursor direction keys, could be employed to communicate direction information and command selections to the processor 604 and to control the movement of the cursor on the display 612.

In one embodiment, the computer system 600 carries out the techniques described in this document by having processor 604 execute one or more sequences of instructions stored in main memory 606. These instructions can be obtained from a remote database or other storage medium. By executing the sequences of instructions contained in main memory 606, processor 604 performs the process steps outlined in herein. In alternative embodiments, hard-wired circuitry may be used in place of or in combination with software instructions.

Storage media may include non-volatile media (e.g. optical or magnetic disks like storage device 610) or volatile media (e.g. dynamic memory like main memory 606). Examples of non-volatile media include optical or magnetic disks, such as storage device 610. Volatile media includes dynamic memory, such as main memory 606. Examples of common forms of storage media include a hard disk, a floppy disk, a flexible disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Transmission media, on the other hand, refers to the media that participates in transferring information between storage media. Examples of transmission media include fiber optics, wireless links, coaxial cables and copper wire including the wires that comprise bus 602. Another possible form of transmission media is acoustic or light waves, such as those generated during radio-wave and infrared data communications.

Further included in Computer system 600 is a Communication Interface 618 linked to the bus 602. This interface allows a two-way data communication coupling to a communication network, for example Network 116 of FIGS. 1 and 2. Examples of communication interfaces 618 include integrated services digital network (ISDN) cards, cable modems, satellite modems, etc. As an alternative example, the communication interface 618 may also be a local area network (LAN) card or a wireless-LAN (WLAN or WiFi) adapter to provide facilities for communication with a compatible LAN. In any such implementation, communication interface 618 sends and receives signals of electrical, electromagnetic or optical kind that carry data streams representing various types of information.

As stated, there are a plurality of useful arrangements that computer system 600 may be configured in, and it is noted that there will be differences while the general architecture of system 600 may be the same independently of the arrangements. By way of example, in case computer system 600 is configured as a high performance server computer, it will typically be equipped with higher-end hardware allowing for a more rapid processing of data, access to memory, and performance of network communications as compared to, for example, an end-user computing system, such as Developer Computer 112.

1. A method for electronic message delivery, comprising
a. receiving a textual input contained in a source code file from a client device, the textual input containing zero or more specific tokens;
b. determining whether the received textual input is of commentary nature and, if so
c. extracting zero or more actions from the received textual input in connection with the contained zero or more specific tokens, each of the zero or more actions containing, based on data extracted from the received textual input, a set of one or more intended receivers and a data payload;
d. translating, by accessing a first configurable directory service, the intended receivers contained in the sets of one or more intended receivers contained in the zero or more extracted actions, into identified receivers on a computer network, resulting in a set of zero or more identified receivers, each identified receiver being linked to its containing action;
e. Delivering, via electronic means, to each identified receiver contained in the set of zero or more identified receivers, one message of a type derived from the action linked to the identified receiver, the message containing a data payload.

2. The method of claim 1 where the intended receivers are determined by accessing a second configurable directory service with the specific tokens contained in the textual input

3. The method of claim 1 where the first configurable directory service contains mappings to external services connected through an API endpoint

4. The method of claim 1 where the first configurable directory service contains identity mappings.

5. The method of claim 1 where, for each of the zero or more actions, zero or more keywords are extracted from the textual input.

6. The method of claim 5 where the delivered message type is partially determined based on the zero or more keywords extracted from the textual input.

7. The method of claim 6 where the partial determination of message type based on the zero or more keywords extracted from the textual input is carried out by accessing a third configurable directory service with the zero or more keywords extracted from the textual input.

8. The method of claim 1 where only a user-selected subset of messages is delivered, wherein the user-selection is carried out through a user interface listing the full set of messages about to be delivered at any given time.

9. The method of claim 1 where the textual inputs are received through submitted commit messages in a source code management system instead of being contained in source code files.

10. The method of claim 1 where multiple textual inputs are received and processed in parallel.

11. A system comprising
a. A processor
b. A communication interface and
c. a non-transitory computer-readable storage medium storing sequences of instructions, which when executed by the processor, cause the processor to:
i. receive a textual input contained in a source code file from a client device, the textual input containing zero or more specific tokens;
ii. determine whether the received textual input is of commentary nature and, if so
iii. extract zero or more actions from the received textual input in connection with the contained zero or more specific tokens, each of the zero or more actions containing, based on data extracted from the received textual input, a set of one or more intended receivers and a data payload;
iv. translate, by accessing a first configurable directory service, the intended receivers contained in the sets of one or more intended receivers contained in the zero or more extracted actions, into identified receivers on a computer network, resulting in a set of zero or more identified receivers, each identified receiver being linked to its containing action;
v. Deliver, via electronic means, to each identified receiver contained in the set of zero or more identified receivers, one message of a type derived from the action linked to the identified receiver, the message containing a data payload.

12. The system of claim 11 where the intended receivers are determined by accessing a second configurable directory service with the specific tokens contained in the textual input

13. The system of claim 11 where the first configurable directory service contains mappings to external services connected through an API endpoint

14. The system of claim 11 where the first configurable directory service contains identity mappings.

15. The system of claim 11 where, for each of the zero or more actions, zero or more keywords are extracted from the textual input.

16. The system of claim 15 where the delivered message type is partially determined based on the zero or more keywords extracted from the textual input.

17. The system of claim 16 where the partial determination of message type based on the zero or more keywords extracted from the textual input is carried out by accessing a third configurable directory service with the zero or more keywords extracted from the textual input.

18. The system of claim 11 where only a user-selected subset of messages is delivered, wherein the user-selection is carried out through a user interface listing the full set of messages about to be delivered at any given time.

19. The system of claim 11 where the textual inputs are received through submitted commit messages in a source code management system instead of being contained in source code files.

20. The system of claim 11 where multiple textual inputs are received and processed in parallel.

21. A computer-implemented method comprising
a. rendering a visualization of a commit graph of a managed source code repository
i. wherein only a subset of branches are selected for rendering based at least in part on user selection;
ii. wherein chains of commits of selected branches, with respective commits on the chain having exactly one parent commit and one child commit, are rendered as collapsed and expandable nodes in the graph
iii. wherein individual nodes in the graph are augmented with special graphical elements pertaining to the underlying commit or set of commits.
b. making available to connected systems a subset of identifiers of the rendered elements in response to user-directed input.
